(19) United States
(12) Patent Application Publication
(10) Pub. No.: US 2015/0167607 A1
(43) Pub. Date: Jun. 18, 2015

(54) METHOD FOR CONTROLLING RELIEF VALVE OF DIESEL COMMON-RAIL SYSTEM

(71) Applicants: Hyundai Motor Company, Seoul (KR); Kia Motors Corp., Seoul (KR)

(72) Inventor: Su Young Park, Uiwang-si (KR)

(73) Assignees: Hyundai Motor Company, Seoul (KR); Kia Motors Corp., Seoul (KR)

(21) Appl. No.: 14/322,397

(22) Filed: Jul. 2, 2014

(30) Foreign Application Priority Data
Dec. 13, 2013 (KR) 10-2013-0155752

(51) Int. Cl. F02M 55/00

(52) U.S. Cl. CPC F02M 55/002

(57) ABSTRACT

A method of controlling a relief valve of a diesel common-rail system may include checking whether in key-off of a vehicle, checking whether an engine stops, and keeping a relief valve operating by keeping a relay of a common-rail controller turned on until the engine stops, even after key-off of the vehicle.

### CROSS-REFERENCE TO RELATED APPLICATION

The present application claims priority of Korean Patent Application Number 10-2013-0155752 filed on Dec. 13, 2013, the entire contents of which application are incorporated herein for all purposes by this reference.

### BACKGROUND OF INVENTION

1. Field of Invention

The present invention relates to a method of controlling a relief valve of a diesel common-rail system which prevents damage to a common-rail due to excessive pressure by not immediately stopping a relief valve, but operating it for a predetermined time even in key-off of a vehicle.

2. Description of Related Art

Common-rail systems may be considered as fuel injection hardware including, as the main parts, a fuel pump compressing fuel at high pressure, a common-rail accumulating and distributing the compressed fuel to the cylinders of an engine, and an injector controlled to inject the fuel to a combustion chamber by an ECU (electronic control unit).

The SCV (Suction Control Valve) of the fuel injection pump that directly controls the rail pressure by adjusting the compression amount of fuel is a normal open type and the PRV (Pressure Relief Valve) for control of preventing excessive instantaneous increase in pressure of the rail is a normal close type.

The PRV of the common-rail is set to be able to operate a solenoid valve in response to a signal from the ECU, and when a desired pressure increases over a predetermined deviation, it instantaneously reduces the rail pressure to the desired pressure by opening the valve by several ms each time through duty control and prevents excessive increase in output change, noise, and system pressure due to a change in injection pressure.

The PRV can be controlled only when the power of the ECU is turned on. Accordingly, when the engine is turned off in which the ECU is turned off, the high-pressure fuel circuit of the fuel system becomes a closed circuit due to PRV-Normal Close, SCV-Normal Open.

When the pressure may be continuously increased (3000 bar or more) with the high-pressure fuel circuit being a closed circuit (engine rotating) and the fuel pressure is increased and maintained at a high level, the common-rail system may be damaged or broken.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to provide a method for controlling a relief valve of a diesel common-rail system which prevents damage to a common-rail due to excessive pressure by not immediately stopping a relief valve, but operating it for a predetermined time even in key-off of a vehicle.

A method of controlling a relief valve of a diesel common-rail system of the present invention includes: checking whether in key-off of a vehicle, checking whether an engine stops, and keeping a relief valve operating by keeping a relay of a common-rail controller turned on until the engine stops, even after key-off of the vehicle.

The method may further include checking a vehicle speed to determine whether the vehicle stops, wherein the relief valve is kept operating by keeping the relay of the common-rail controller turned on until the engine stops and the vehicle stops, even after key-off of the vehicle in the keeping of a relief valve operating.

In the checking of the vehicle speed, it may be determined that the vehicle stops when the vehicle speed is equal to or less than a second reference value. In the checking of whether the engine of the vehicle stops, it may be determined that the engine stops when an RPM of the engine is equal to or less than a first reference value. In the checking of whether the engine of the vehicle stops, it may be determined that the engine stops when a signal value from an engine RPM pulse sensor or a signal value from an engine cam sensor is not found.

The common-rail controller may be an engine ECU.

The method of controlling a relief valve of a diesel common-rail system of the present invention keeps a relief valve operating by keeping a relay of a common-rail controller turned on until an engine stops even in key-off of a vehicle.

According to the method of controlling a relief valve of a diesel common-rail system having the structure described above, it is possible to prevent damage to a common-rail due to excessive pressure by not immediately stopping a relief valve, but operating it for a predetermined time, even in key-off of a vehicle.

That is, the relief valve of the ECU keeps operating by keeping the ECU relay operating until the RPM of the engine and the vehicle speed drop to a predetermined value or less even if a user stops the engine, so that it is possible to preclude an influence from an increase in fuel pressure generated by a pump that mechanically rotates.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

The above and other features of the present invention will now be described in detail with reference to certain exemplary embodiments thereof illustrating the accompanying drawings which are given herein below by way of illustration only, and thus are not limitative of the present invention, and wherein:

FIG. 1 is a flowchart illustrating an exemplary method of controlling a relief valve of a diesel common-rail system according to the present invention; and

FIG. 2 is a diagram illustrating an exemplary method of controlling a relief valve of a diesel common-rail system according to the present invention.

It should be understood that the appended drawings are not necessarily to scale, presenting a somewhat simplified representation of various preferred features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

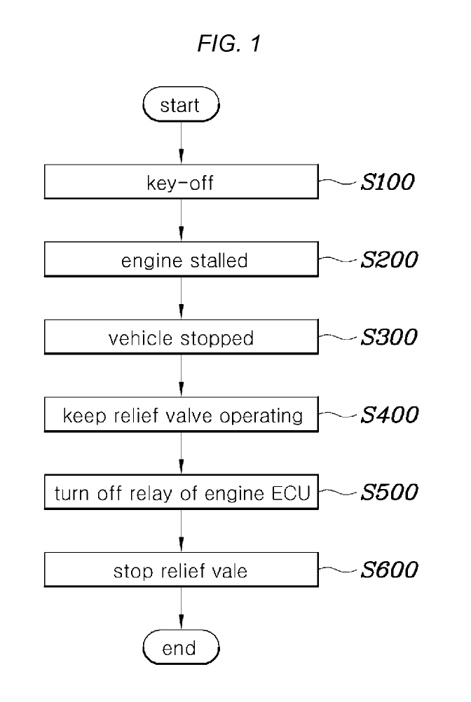

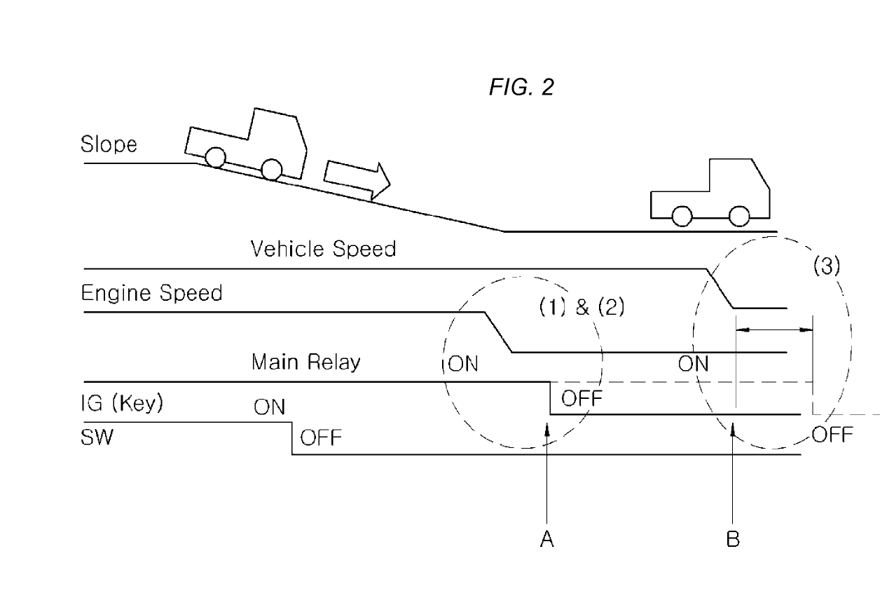

FIG. 1 is a flowchart illustrating a method of controlling a relief valve of a diesel common-rail system according to various embodiments of the present invention and FIG. 2 is a diagram illustrating the method of controlling a relief valve of a diesel common-rail system according to various embodiments of the present invention.

A method of controlling a relief valve of a diesel common-rail system of the present invention keeps a relief valve operating by keeping a relay of a common-rail controller turned on until an engine stops even in key-off of a vehicle.

As illustrated in the flowchart of FIG. 1, the method of controlling a relief valve of a diesel common-rail system of the present invention includes: checking key-off of a vehicle (S100); checking whether an engine stops (S200); and keeping a relief valve operating by keeping a relay of a common-rail controller turned on until the engine stops even after key-off of the vehicle (S400 and S500). In some embodiments, the method further includes checking a vehicle speed, whether a vehicle is in stop (S300), and can keep the relief valve operating by keeping the relay of the common-rail controller turned on until the engine stops with the vehicle stopped even after key-off of the vehicle, in the keeping of a relief valve operating (S400, 5500, and S600).

In the checking of a vehicle speed, it can be determined that the vehicle is in stop, when the vehicle speed is a first reference value or less.

In particular, in the checking of an engine, it can be determined that the engine is in stop, when the RPM of the engine is a second reference value or less. In the checking of an engine, it can be determined that the engine is in stop, when a signal value from an engine RPM pulse sensor or a signal value from an engine cam sensor is not found out. The common-rail controller may be an engine ECU.

That is, in order to prevent the common-rail system from being damaged or broken, a control logic that does not turn off the relay of the ECU is added so that the pressure of the common-rail which abnormally increases can be released by keeping the PRV (relief valve) operating, when the engine does not stop.

When engine stall is not found out for a predetermined time with an engine stop condition added in the off-condition of the ECU power relay, after key-off, the relay is not turned off. Further, fuel is not injected, but power is supplied to the ECU, so the relief valve is controlled to operate.

In the engine stall conditions, when any one of a sensor signal valve of an engine RPM pulse or a cam sensor pulse signal value is inputted to the ECU during a predetermined time, it is determined that the engine does not stall.

After key-off, when the vehicle signal condition is made to satisfy simultaneously with the off-condition of the ECU power relay, a condition of a predetermined vehicle speed or less is added, and when the vehicle stops, the relay is turned off, the ECU is turned off, and the PRV is stopped.

That is, the PRV of the ECU is kept operating by keeping the ECU relay operating until the RPM of the engine and the vehicle speed drop to a predetermined value or less even if a user stops the engine, so that it is possible to preclude an influence from an increase in fuel pressure generated by a pump that mechanically rotates.

FIG. 2 is a diagram illustrating the method of controlling a relief valve of a diesel common-rail system according to an embodiment of the present invention. The ECU relay may be turned off at the point A of time with the engine stopped after key-off, and the ECU relay may be turned off at the point B of time with the vehicle completely stopped. Preferably, in some embodiments, it is preferable to keep the relief valve operating when the engine stops and the vehicle stops in order to completely preclude a condition in which high pressure is produced.

According to the method of controlling a relief valve of a diesel common-rail system having the structure described above, it is possible to prevent damage to a common-rail due to excessive pressure by not immediately stopping a relief valve, but operating it for a predetermined time, even in key-off of a vehicle.

That is, the relief valve of the ECU is kept operating by keeping the ECU relay operating until the RPM of the engine and the vehicle speed drop to a predetermined value or less even if a user stops the engine, so that it is possible to preclude an influence from an increase in fuel pressure generated by a pump that mechanically rotates.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method of controlling a relief valve of a diesel common-rail system, comprising:
checking whether in key-off of a vehicle;
checking whether an engine stops; and
keeping a relief valve operating by keeping a relay of a common-rail controller turned on until the engine stops, even after key-off of the vehicle.

2. The method of claim 1, further comprising:
checking a vehicle speed to determine whether the vehicle stops,
wherein the relief valve is kept operating by keeping the relay of the common-rail controller turned on until the engine stops and the vehicle stops, even after key-off of the vehicle in the keeping of a relief valve operating.

3. The method of claim 2, wherein in the checking of the vehicle speed, it is determined that the vehicle stops when the vehicle speed is equal to or less than a second reference value.

4. The method of claim 1, wherein in the checking of whether the engine of the vehicle stops, it is determined that the engine stops when an RPM of the engine is equal to or less than a first reference value.

5. The method of claim 1, wherein in the checking of whether the engine of the vehicle stops, it is determined that the engine stops when a signal value from an engine RPM pulse sensor or a signal value from an engine cam sensor is not found.

6. The method of claim 1, wherein the common-rail controller is an engine ECU (electronic control unit).

7. A method of controlling a relief valve of a diesel common-rail system, the method comprising:
keeping a relief valve operating by keeping a relay of a common-rail controller operating until an engine stops even in key-off of a vehicle.
